(19) United States
(12) Patent Application Publication
(10) Pub. No.: US 2008/0190782 A1
(43) Pub. Date: Aug. 14, 2008

(54) Method for Voltametruc Electrochemical Analysis and Implementing Device Therefor

(76) Inventors: Olivier Lavastre, Gahard (FR); Didier Floner, Rennes (FR); Florence Geneste, Servon Sur Vilaine (FR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/911,456

(22) PCT Filed: Mar. 28, 2006
(86) PCT No.: PCT/EP2006/061112

§ 371 Date: Apr. 8, 2008

(30) Foreign Application Priority Data
Apr. 12, 2005 (FR) 0503654

(51) Int. Cl. G01N 27/26

(52) U.S. Cl. 205/775

(57) ABSTRACT

The invention concerns a method for voltammetric electrochemical analysis of a liquid solution, for detecting and/or assaying in said solution at least one chemical species. The invention is characterized in that the method includes the following steps: contacting a sample of said solution with a single analyzing support (10) having at least two working electrodes (12) each belonging to a separate electrochemical analysis cell, each analysis cell further including a counter-electrode (13) and a reference electrode; performing a single and different measurement of said sample in each of said analysis cells, by applying an independent and different potential to each of the working electrodes (12); producing at least one voltammogram of said sample, based on said measurements; deducing from said voltammogram data concerning the detection and/or assay of said at least one chemical species in said sample.

The field of the invention is that of chemistry and more specifically methods for the electrochemical analysis of liquid solutions or gases in order to detect and/or assay chemical species.

One commonly used technique for the qualitative and quantitative analysis of electrochemical species is voltammetry. This technique is based on measuring the current flow resulting from the reduction or oxidation of the species present under the effect of a controlled variation in the potential difference between two electrodes.

A large number of species (or compounds) can be analysed in this way, be these organic or inorganic compounds, cations or anions.

A voltammetric analyser therefore consists of an electrochemical analysis cell based on a system comprising three electrodes which are immersed in the solution to be analysed.

The three electrodes are:
a working electrode (also known as the indicator electrode);
a reference electrode; and
a counter-electrode (also known as the auxiliary electrode).

The voltammetric analyser also consists of a potentiostat which makes it possible to impose a potential difference between the working electrode and the counter-electrode, and to impose a specific and constant potential on the reference electrode so that the potential imposed on the working electrode is precisely defined.

The curves I=f(E) obtained show the current measured (at precise times while imposing the potential) as a function of the potential, and make it possible to determine qualitatively and/or quantitatively the one or more chemical species present in the solution.

These curves make it possible in particular to obtain the value of the limiting diffusion current Iₗᵢₘᵢₜ, which is proportional to the concentration of the species, and the value of the half-wave potential E_{1/2} (also known as the half-reaction potential) that is characteristic of the oxidised or reduced species.

The current I can be measured continuously and the curve I=f(E) obtained is called a voltammogram. Different voltammetric analysis techniques can be used depending on the variation in potential that is imposed, which may be linear or modulated.

A first known technique is staircase voltammetry (SCV), also known as potential step voltammetry. According to this technique, a series of potential plateaus of regularly increasing value (constant step height) and of constant duration (so as to form a staircase) is applied, and the current is measured by sampling after a certain duration of the plateau. When the duration and magnitude of the plateau are sufficiently low, the method is equivalent to linear scan voltammetry (LSV).

A second known technique is potential pulse voltammetry, also known as normal pulse voltammetry (NPV). According to this technique, a series of potential pulses is imposed and the intensity of the current is measured a certain time “t” after the jump. After each pulse, the potential returns to its initial value and the magnitude of each pulse is varied regularly so as to carry out a potential sweep similar to a scanning process.

A third known technique is differential voltammetry using potential pulses, also known as differential pulse voltammetry (DPV). According to this technique, a series of potential pulses is imposed and the difference in current before and after the jump is measured. Each pulse is of constant magnitude but the return potential is different from the potential before the pulse, which allows an evolution of the potential and a potential sweep. Each difference in current that is measured is represented as a function of the potential reached by the jump, which is ultimately equal to representing the derivative of the curve I=f(E) when the interval between two measurements tends towards zero.

Furthermore, the electrochemical analysis methods use different types of electrodes, and in particular different types of working electrodes.

In the simplest method, a solid working electrode is immersed in the solution to be analysed. Said electrode may be of various types, that is to say may be made of various conductive materials, such as
metals (platinum, gold, silver, copper or nickel for example, or alloys);
non-metallic materials (graphite or glassy carbon for example);
organic materials such as polymers for example.

The working electrode used for the analysis may therefore be selected in particular as a function of the oxidation or reduction potential of a particular species that it is desired to analyse.

However, this method has two major drawbacks. Firstly, during the measurements, phenomena of adsorption, deposition or even corrosion of the electrode are liable to occur and to modify the surface of the electrode, thereby disrupting the current response.

Secondly, account should also be taken of the variation in concentration of the studied substrate (or chemical species) with the variation in the potential. This is because, during the electrolysis of the oxidant for example, the concentration of the substrate at the surface of the electrode decreases relative to its initial concentration in the solution, away from the electrode. This phenomenon is the reason behind a concentration gradient and the appearance of a diffusion layer having a thickness of generally a few microns at the surface of the electrode.

The following formula describes the relationship between the intensity of the current I and the concentration Cₒₓ of the substrate (that is to say of the oxidant):

I=m₀(C_{Ox}^{solution}−C_{Ox}^{electrode}),

in which m₀ is the mass transfer coefficient of the oxidant.

In order to overcome these drawbacks, known techniques from the prior art provide various alternatives such as stirring the solution during the measurements by means of a magnetic stirrer for example, or using a rotating electrode.

The rotating electrode consists of an electrode which forms a disc, which may be made for example of platinum, silver or glassy carbon, and on which a rotational movement is imposed.

Although these techniques make it possible to effectively homogenise the solution and therefore to renew it at the electrode, nevertheless they do not make it possible to renew the surface of the electrode during the measurements, the electrode surface therefore being subject to the risks of alteration described above.

The known method which makes it possible to renew the active surface of the disc electrode is the mechanical polishing of said surface. Consequently, the curve I=f(E) must be established point by point, with polishing of the electrode necessarily taking place between each measurement. Furthermore, the intensity of the current must be measured at a precise time after the imposing of the potential. It will easily be understood that the establishment of this curve is very tedious, takes a long time and includes many incorrect points.

Another known technique of the prior art makes it possible to renew the surface of the working electrode for each measurement. It involves the mercury dropping electrode. According to this technique, which is known as polarography, a drop of mercury grows at the end of a capillary tube which is continuously supplied with mercury. The size of the drop increases until it detaches under the effect of its own weight. A new drop then forms at the end of the capillary tube. The drop is thus renewed for each measurement and is substantially identical to the previous drop. The current is measured at a precise instant during the life span of the drop or corresponds to a value averaged over the entire life span of the drop.

This technique therefore effectively renews the active surface of the electrode. Furthermore, the falling of the drop agitates the solution and cancels out the substrate depletion effect. Each new drop thus starts its growth in a solution corresponding to the initial solution.

However, a first drawback of this technique is that it requires the use and handling of mercury, which is a toxic compound and therefore requires particular and restrictive use conditions in order to satisfy current health, safety and environmental standards.

Another drawback of this technique is that the electroactivity range of mercury is between +0.2 V and −0.2 V, depending on the pH of the solution. This range makes it possible to study the electroactive species up to a value on the cathode side which is not reached by other metals. On the other hand, this range is very limited on the anode side (+0.2 V), contrary to the other materials (for example +1.5 V for platinum and gold; +1.8 V for carbon, etc.).

The object of the invention is in particular to overcome these drawbacks of the prior art.

More specifically, one object of the invention is to provide a new technique which allows simple and rapid analysis of a solution, and in particular the rapid detection and/or assaying of one (or several) chemical species.

Another object of the invention is to propose a successful technique which makes it possible to circumvent the phenomena of depletion of the species in the solution that has reacted close to the working electrode, and also to prevent any alteration of the active surface of the working electrode during the measurements, so that the measurements carried out are rigorous and precise.

Yet another particular object of the invention, which is achieved by certain embodiments, is to propose a technique which offers good modularity with regard to the redox potential of the species to be analysed, and which is easy to implement by the user.

These objects, along with others which will become more clearly apparent below, are achieved by means of a method for voltammetric electrochemical analysis of a liquid solution, which makes it possible to detect and/or assay at least one chemical species in said solution.

According to the invention, the method comprises the following steps:
bringing a sample of said solution into contact with a single analysis support which has at least two working electrodes, each belonging to a separate electrochemical analysis cell, each analysis cell furthermore comprising a counter-electrode and a reference electrode;
carrying out a single and different measurement of said sample in each of said analysis cells, by applying an independent potential to each of said working electrodes;
creating at least one voltammogram of said sample, based on said measurements;
deducing, from said voltammogram, information relating to the detection and/or assaying of said at least one chemical species in said sample.

Thus, the invention consists in analysing a solution by means of a single analysis support which has a plurality of working electrodes, each of these being used to carry out just one single measurement, independent potentials being applied thereto.

According to this technique, since each working electrode is used for just one single measurement, said working electrodes are therefore indeed renewed for each of the measurements.

An analysis cell which makes it possible to carry out a measurement comprises:
a working electrode;
a counter-electrode; and
a reference electrode.

As mentioned above, the working electrode of each analysis cell is located on the analysis support. On the other hand, as will be explained below, the counter-electrode and/or the reference electrode which complete an analysis cell may for their part be located on the same analysis support or, on the contrary, may be attached to a second support (also referred to as the additional support) which is separate from the analysis support for example.

The concept of a “separate” analysis cell means that the working electrodes of the different cells are separate. However, as will be explained below, one counter-electrode and/or one reference electrode may on the other hand be common to several or to all the analysis cells.

The chemical species present in the solution and analysed by means of this method may be ionic, molecular or gaseous (in the form of a dissolved gas).

Advantageously, one and the same sample of the solution is in contact (simultaneously) with all of the electrochemical cells of the analysis support when carrying out the measurements (that is to say with all of the electrodes constituting an analysis cell). The analysis support may for example be immersed in the sample of the solution to be tested.

According to a first advantageous embodiment of the invention, the measurements are carried out simultaneously by each of the analysis cells. The independent potentials are then applied simultaneously to the working electrodes of the different cells.

Since each measurement is carried out at the same time, the composition of the sample at each electrode is identical and corresponds to the initial composition.

Furthermore, this makes it possible to reduce as far as possible the time required to create the voltammogram(s) and therefore to analyse the sample.

According to a second advantageous embodiment of the invention, the measurements are carried out in succession by the analysis cells.

Advantageously, the duration separating two successive measurements will be less than a maximum duration. Limiting the duration between two measurements makes it possible to ensure that the current response in one cell is not affected by the electrochemical reactions taking place in the neighbouring cells. At the time when one measurement is carried out, the composition of the sample around the cell is not modified by the previous measurement(s) and therefore is not depleted of the chemical species that has reacted during the measurement.

Furthermore, limiting the duration between the measurements by the different analysis cells also makes it possible to reduce the overall time required to analyse the sample.

Advantageously, when the measurements are carried out in succession by the different cells, one counter-electrode and/or one reference electrode is/are common to at least two analysis cells. It may then be provided that one and the same counter-electrode and/or one and the same reference electrode is/are used to carry out measurements by different cells, the measurements being carried out in succession, and these electrodes do not risk being altered during the course of the measurements.

The reference electrode and/or the counter-electrode which is/are common to different analysis cells may be located on the analysis support which carries the working electrodes, or on an additional support.

Furthermore, it is of course possible to combine the two previous embodiments by envisaging that the measurements are carried out at the same time for some electrochemical cells while, on the other hand, they are slightly offset temporally for some other analysis cells.

It will thus be understood that the technique of the invention allows rapid analysis of a sample since the different measurements can be carried out simultaneously. One or more different voltammograms can thus be created and used, based on the measurements carried out.

Advantageously, said measurements carried out make it possible to implement at least one voltammetric analysis belonging to the group comprising:
potential step voltammetry;
normal pulse voltammetry;
differential pulse voltammetry.

These different methods of analysis can furthermore be combined for one and the same analysis support, it being possible for a first set of cells to create a voltammogram by potential step voltammetry and for a second set of cells to create a voltammogram by differential pulse voltammetry for example, in order to increase the sensitivity of the analysis.

Combining the various types of analysis may therefore make it possible to obtain more precise results with regard to determining the species that are present and the concentration thereof.

Advantageously, the method according to the invention may be implemented prior to a more in-depth and more precise study of the sample. Use may therefore be made of a support with a reduced number of working electrodes to create a voltammogram, so as to rapidly determine the presence or absence of a particular chemical species in the solution for example.

By way of example, use may be made of at least ten measurements from ten working electrodes in order to create a voltammogram. The greater the number of measurements carried out in order to create a voltammogram, the more precise the analysis.

The invention also relates to an analysis support for implementing a method of electrochemical analysis as described above. Such a support has at least two working electrodes, each belonging to a separate electrochemical analysis cell, and it also has at least one network of electrical connections which allows the application of an independent potential to each of the working electrodes.

Thus, a plurality of working electrodes are distributed over an analysis support and each make it possible to carry out one single and independent measurement, the network of electrical connections making it possible to apply an independent potential to the different working electrodes.

An analysis support according to the invention may also be called an “analysis plate” or “plate” or even “chip”.

Advantageously, the different working electrodes of an analysis support have the same dimensions. In particular, the working electrodes belonging to the cells used to create one and the same voltammogram have the same dimensions. This is because it is important during the measurements that the working electrodes which make it possible to carry out measurements for creating a voltammogram have a substantially identical active surface area.

Preferably, at least two of the analysis cells comprise a working electrode made of different materials. It may be provided that the working electrodes of one and the same analysis support (or chip) are made of different materials.

This may make it possible to create several voltammograms from one and the same analysis support, each voltammogram corresponding to the measurements obtained from cells having working electrodes of the same type.

During the detection and/or analysis of a chemical species, all the working electrodes are not necessarily adapted as a function in particular of the material from which the working electrode is made and the redox potential of the species to be analysed or the pH conditions of the solution. It may therefore be necessary to envisage different types of working electrode for analysing the chemical species of a solution. The benefit of using a support with working electrodes of different types will be understood below.

Advantageously, said working electrodes of the analysis cells are made of at least one material belonging to the group comprising metals and conductive non-metals.

The metals used may be for example gold, platinum, silver, copper, chromium, zinc, tin, nickel or lead or alloys. The conductive non-metallic materials may be for example graphite, glassy carbon, doped silicon or organic materials such as conductive polymers (polypyrrole, polythiophene or polyaniline for example).

The working electrodes may also be chemically modified electrodes. Such modified electrodes thus have a mediator which is designed to react in the presence of one or more particular chemical species in a solution to be analysed. The mediator may be attached to the working electrode covalently or by way of adsorption phenomena.

The use of a modified electrode may in particular make it possible to detect and/or assay non-electroactive substances.

The modification of the surface of the electrode may be achieved by immobilising for example organic compounds, organometallic or ionic fragments, DNA strands, enzymes or other molecules of high molecular weight.

Furthermore, voltammetric analysis can be difficult in the case of solutions comprising several different chemical species. This is because a measurement by means of one analysis cell therefore runs the risk of being due to several compounds and of not being characteristic of a single chemical species.

The use of a support which has working electrodes of different types may thus allow a discriminant analysis of the different species by comparing the different voltammograms obtained with each of the different electrodes. This is because the behaviour of the chemical species varies depending on the working electrode used.

Different voltammograms are thus created from the measurements carried out by analysis cells with working electrodes of different types.

Preferably, the working electrodes used to create one and the same voltammogram have the same dimensions.

Preferably, the working electrodes of the different analysis cells are distributed over one and the same face of the analysis support. The sample of the solution to be analysed may for example be deposited on this face of the analysis support.

Advantageously, the working electrodes are spaced apart by at least 100 μm

Advantageously, the method according to the invention may be implemented prior to a more in-depth and more precise study of the sample. Use may therefore be made of a reduced number of measurements (and therefore a reduced number of working electrodes) to create a voltammogram, so as to rapidly determine the presence or absence of a particular chemical species in the solution for example.

By way of example, use may be made of an analysis support with one hundred working electrodes. These may be distributed for example in ten rows of ten. In general, the greater the number of measurements carried out in order to create a voltammogram, the more precise the analysis.

Furthermore, the greater the number of working electrodes of different types that are used, the more precise the analysis since this can make it possible to analyse chemical species with very different redox potentials.

Moreover, this will allow a better interpretation of the voltammograms obtained. Comparison of the voltammograms created from the measurements obtained by working electrodes of different types makes it possible to determine whether the curves obtained are characteristic of a single species or on the contrary of several different chemical species.

It is possible for example, in the case of an analysis support with one hundred working electrodes, to provide for a distribution of said working electrodes over ten rows, with working electrodes of different types being located on different rows.

Advantageously, the working electrodes of the different cells have the same shape and the same dimensions and therefore have a substantially identical active surface area.

As mentioned above, an analysis cell consists of:
a working electrode;
a counter-electrode; and
a reference electrode.

According to a first advantageous approach of the invention, it may be provided that the counter-electrodes and/or the reference electrodes which complete an analysis cell are also located on the analysis support which carries the working electrodes. In this case, they will preferably be located close to the working electrode of the analysis cell to which they belong.

According to this approach of the invention, it may be provided that, according to a first embodiment, each counter-electrode and each reference electrode are specific to one analysis cell, in particular when the measurements are carried out simultaneously by each of the analysis cells, the potentials being applied simultaneously to the different working electrodes.

When the different electrodes constituting an analysis cell are specific to the latter and are located close to one another, they may be grouped together over a zone measuring 100 μm to 1000 μm on each side for example, each of the zones then defining an analysis cell, and the different zones being separated by a distance of 10 μm to 1 mm.

However, it may also be provided, according to a second embodiment, that a counter-electrode and/or a reference electrode is common to several analysis cells.

This may in particular be the case when the measurements are carried out in succession, that is to say when the potentials are applied successively to the different working electrodes.

According to this embodiment, it may also be provided that the analysis support carrying the working electrodes also comprises a counter-electrode close to each working electrode, and that the counter-electrodes are electrically connected to one another. This makes it possible for each working electrode to be spatially close to the common counter-electrode.

The use of common counter-electrodes and/or of common reference electrodes in the case of measurements carried out in succession makes it possible in particular to limit the number of electrical connections on the analysis support. This makes it possible to simplify and limit the costs associated with the production thereof.

The invention also relates to an additional support which is intended to cooperate with an analysis support as presented above, having at least one counter-electrode and/or at least one reference electrode belonging to the analysis cells.

This is because, according to a second advantageous approach of the invention, it may be provided that the counter-electrodes and/or the reference electrodes which complete an analysis cell are located on an additional support and not on the analysis support which carries the working electrode.

They are then preferably distributed in such a way that the three electrodes forming an analysis cell, and making it possible to carry out a measurement, are close to one another. The additional support may for example be placed opposite the analysis support and parallel to the latter, with a small distance separating them.

The distance separating the two supports may be 5 mm for example.

The counter-electrodes and/or the reference electrodes may then be placed on the additional support in such a way that they are directly opposite the working electrode with which they form an analysis cell.

The space between the two supports then preferably comprises the sample of the solution to be analysed, so that the latter is in contact simultaneously with the two supports (that is to say with the different electrodes carried by the supports).

It is of course also possible to combine the two approaches and to provide that the counter-electrodes are located on the analysis support, close to each working electrode, and that only the reference electrodes are located on the additional support, or vice versa.

As in the previous case, two embodiments may be envisaged according to this second approach:

According to a first embodiment, each reference electrode and each counter-electrode is specific to each analysis cell. This is the case in particular when the measurements are carried out simultaneously by each analysis cell.

According to a second embodiment of the invention, it is possible on the other hand to provide a single counter-electrode and/or a single reference electrode which is/are common to the different analysis cells, as described above. This may be the case in particular when the measurements are carried out in succession, that is to say when the potentials are applied successively to the different working electrodes. A single reference electrode and/or a single counter-electrode located on the additional support may then be common to the different working electrodes.

The additional support carrying the common counter-electrode and/or the common reference electrode may for example have the shape of a strip. This is because it is advantageous, with regard to the precision of the measurements, if the common reference electrode and/or the common counter-electrode is/are close to the different working electrodes of the analysis support.

The use of common counter-electrodes and/or of common reference electrodes in the case of measurements carried out in succession makes it possible in particular to limit the number of electrical connections for the additional support carrying them and thus makes it possible to simplify and limit the costs associated with the production thereof.

Moreover, when, according to the second approach of the invention, an additional support carrying the counter-electrode(s) and/or the reference electrode(s) is used, this may then optionally be reused for subsequent analyses, after having been suitably washed. This is because the counter-electrode(s) and/or the reference electrode(s) do not present any risk of alteration during use, unlike the working electrodes. Thus, successive measurements using one and the same additional support does not present any risk of impairing the correctness of the measurements.

This makes it possible to limit costs, since only the analysis support carrying the working electrodes is changed systematically for each analysis.

The invention also relates to a device for implementing an electrochemical analysis method as described above. Such a device comprises:
first receiving means for receiving at least one analysis support as described above;
second receiving means for receiving at least one sample;
means for bringing said at least one analysis support into contact with said sample;
means for applying an independent potential to each of said working electrodes and for measuring said sample in each of said analysis cells.

The device thus comprises receiving means at which the analysis support is placed for each analysis, each support being used for just one single analysis.

It may also be provided that the device is designed to receive several analysis supports, in order to be able to simultaneously analyse different samples that may come from different solutions.

Preferably, the device comprises means for creating at least one voltammogram based on the measurements.

Furthermore, the device may also comprise third receiving means for receiving an additional support as described above which comprises at least one counter-electrode and/or at least one reference electrode, as well as means for bringing said sample into contact with said additional support.

This case may be envisaged when the analysis support which carries the working electrodes of the analysis cells does not carry the reference electrodes and/or the counter-electrodes. It has already been mentioned above that one and/or the other of said electrodes may be located on an additional support.

Advantageously, the device also comprises means for deducing, from said at least one voltammogram, information relating to the detection and/or assaying of said at least one chemical species in the sample.

Such a device therefore makes it possible to rapidly create one or more voltammograms and to analyse the species present in a sample of a solution.

Advantageously, the device is portable. It will be understood that there is a benefit in making it possible to produce a portable device, compared to the known methods according to the prior art which allow rigorous voltammetric analysis, such as polarography using a dropping mercury electrode, which require bulky and expensive apparatus and are therefore difficult to move.

The device according to the invention can thus be transported and used directly at the location of the solution to be analysed, so as to determine for example whether a more in-depth analysis is required and then to carry out the latter in the laboratory.

Other features and advantages of the invention will become more clearly apparent from reading the following description of one preferred embodiment of the invention, which is given by way of non-limiting example, and from the appended drawings, in which:

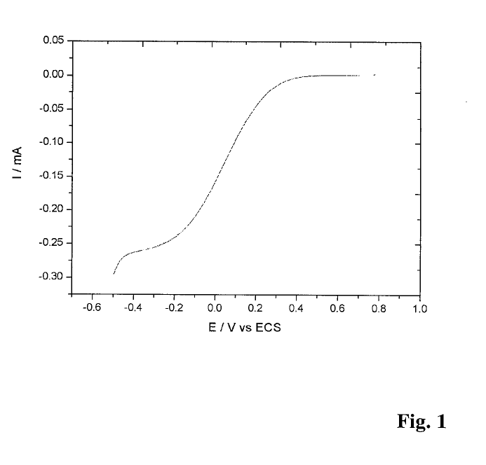

FIG. 1 shows a voltammogram obtained by a known technique from the prior art for a solution of Fe³⁺ at a concentration of 10⁻² mol/l⁻¹ in sulphuric acid H₂SO₄ at 0.5 mol/l⁻¹;

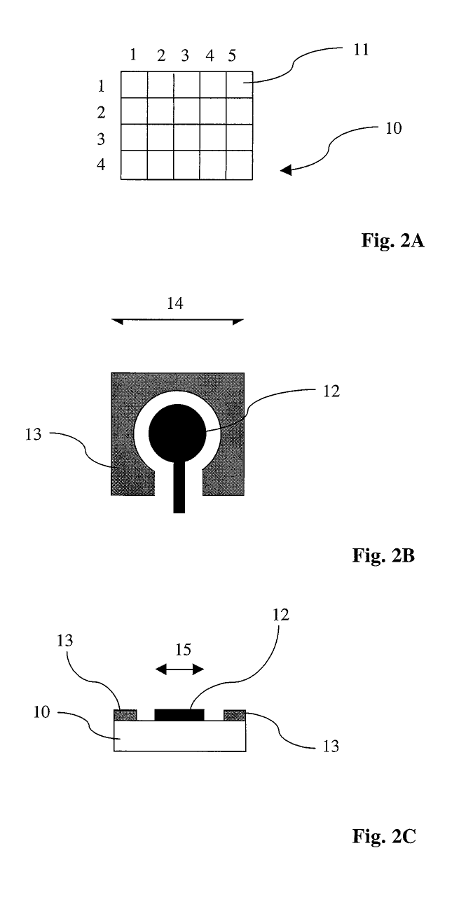

FIGS. 2A, 2B and 2C are simplified schematic views of an analysis support according to the invention;

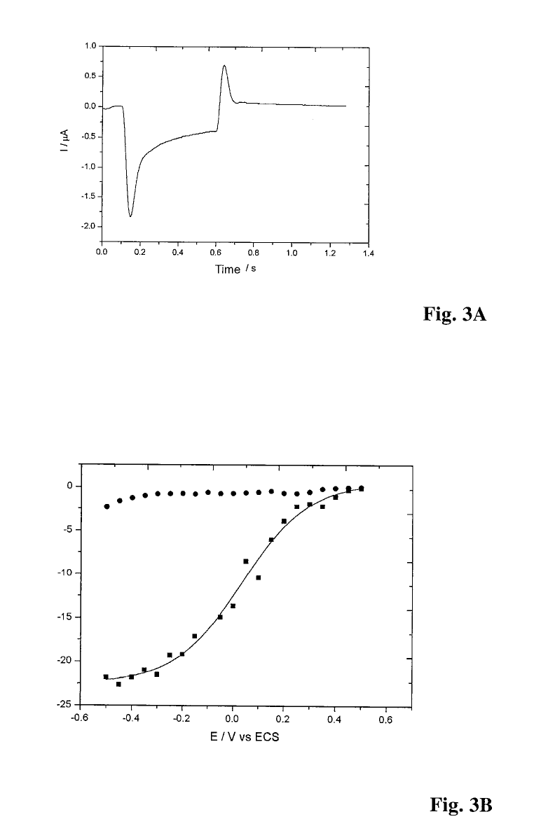

FIGS. 3A and 3B respectively show the current measurements for an analysis cell and a voltammogram obtained by potential step voltammetry based on a method according to the invention for a solution of Fe³⁺ at a concentration of 10⁻² mol/l⁻¹ in sulphuric acid H₂SO₄ at 0.5 mol/l⁻¹;

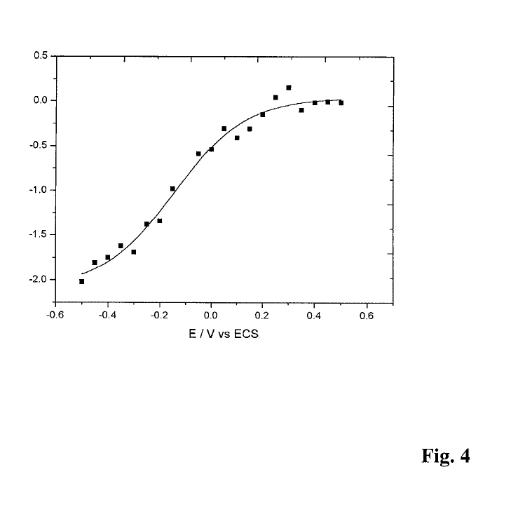

FIG. 4 shows a voltammogram obtained by potential step voltammetry based on a method according to the invention for a solution of Fe³⁺ at a concentration of 10⁻³ mol/l⁻¹ in sulphuric acid H₂SO₄ at 0.5 mol/l⁻¹;

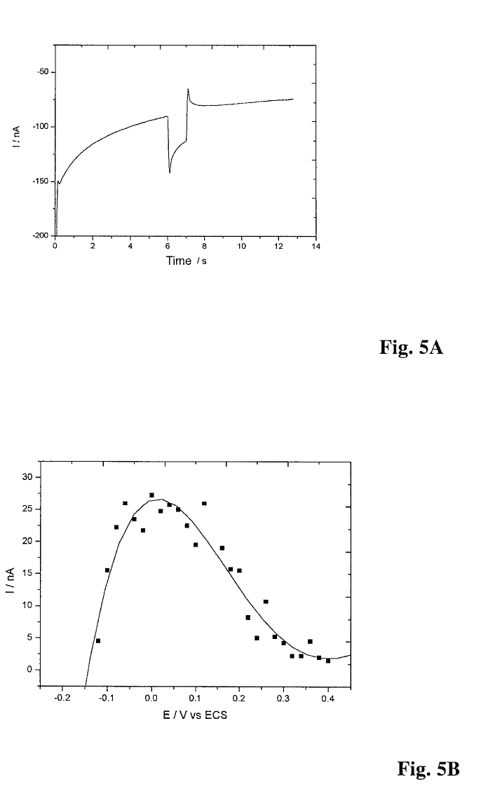

FIGS. 5A and 5B respectively show the current measurements for an analysis cell and a voltammogram obtained by differential pulse voltammetry based on a method according to the invention for a solution of Fe³⁺ at a concentration of 10⁻³ mol/l⁻¹ in sulphuric acid H₂SO₄ at 0.5 mol/l⁻¹;

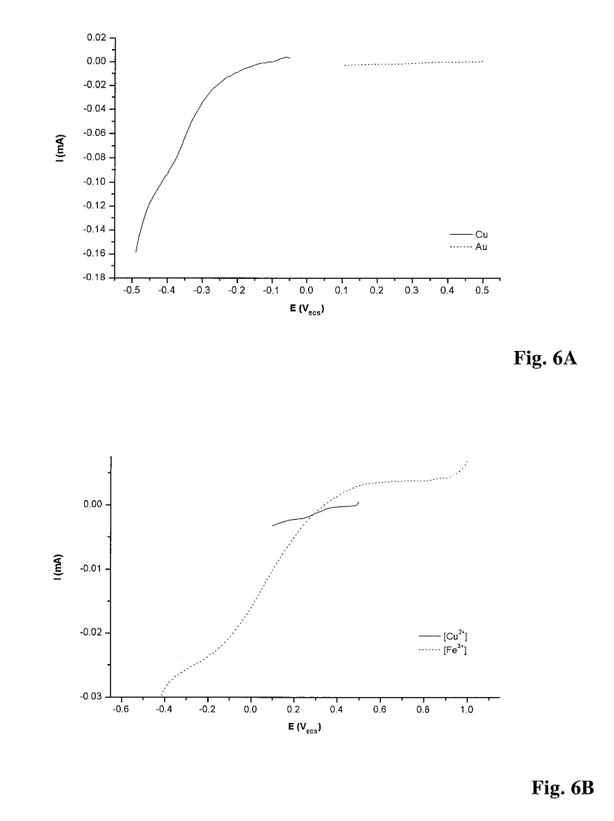

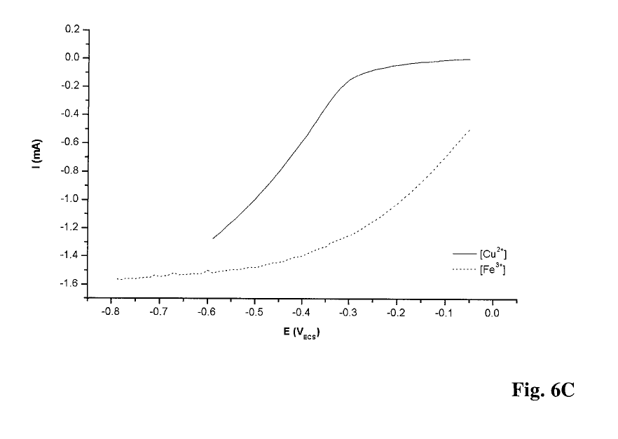

FIGS. 6A, 6B and 6C respectively show the voltammograms obtained for a solution of Cu²⁺ on a gold and copper electrode, for a solution of Cu²⁺ and a solution of Fe³⁺ on a gold electrode, and for a solution of Cu²⁺ and Fe³⁺ on a copper electrode.

The invention therefore presents a new technique which makes it possible to analyse a sample of a solution by voltammetry, while ensuring that the sample at the surface of the working electrode is renewed so that it corresponds to the initial composition, and which also renews the surface of the working electrode during the measurements that are required in order to create a voltammogram. According to the invention, the method uses a support which has a plurality of working electrodes, each belonging to a separate electrochemical analysis cell that is in contact with the sample, each of the working electrodes being used to carry out just one single measurement of the sample.

An electrochemical analysis cell for implementing said method consists of a working electrode, a reference electrode and a counter-electrode.

The invention thus makes it possible to carry out a rigorous and rapid analysis of the chemical species present in a solution.

FIG. 1 shows a voltammogram I=f(E) obtained according to a known technique of the prior art by means of linear scan voltammetry on a rotating gold electrode forming a disc with a diameter of 3 mm. A saturated calomel electrode was used as the reference electrode.

The solution analysed is a solution of Fe³⁺ at a concentration of 10⁻² mol/l⁻¹ in sulphuric acid H₂SO₄ at 0.5 mol/l⁻¹. The applied potentials automatically evolve in steps of 1 mV and at a rate of variation of the potential equal to 20 mV/s.

This voltammogram makes it possible to obtain the following values for the Iₗᵢₘᵢₜ and for the half-wave potential E_{1/2}: Iₗᵢₘᵢₜ=0.21 mA and E_{1/2}=0.06 V. The limit corresponds to the difference in intensity between the lower and upper plateaus of the curve, and the half-wave potential E_{1/2} corresponds to the value of the potential at the point of inflection of the curve.

This value of the half-wave potential of 0.06 V is characteristic of the pair Fe²⁺/Fe³⁺ under such analysis conditions (solvent: H₂SO₄ at 0.05 mol/l⁻¹, gold working electrode, saturated calomel reference electrode).

FIG. 2A is a basic, schematic and simplified view of an analysis support 10 according to the invention which has twenty separate zones 11, each comprising a working electrode, said working electrodes being distributed over four rows of five at equal spacings from one another.

The number of working electrodes distributed over an analysis support 10 may of course vary depending on the level of precision of the voltammograms that it is desired to create.

The dimensions of a working electrode may vary. However, the dimensions of the working electrodes of one and the same support, or at the very least of the working electrodes belonging to analysis cells that make it possible to create one and the same voltammogram, have the same shapes and the same dimensions. This is because the dimensions of the surface of the working electrode influence the values of the currents during the measurements.

The distance between the different electrodes, and in particular between the different working electrodes, may also vary, although short-circuits must be avoided. The risk of short-circuits limits the increase in surface density of the working electrodes on the analysis support. In the case where all the electrodes (working electrode, counter-electrode and reference electrode) of an analysis cell are present on the analysis support, it is the density of these different electrodes that has a limiting effect.

FIG. 2B shows one zone 11 of the analysis support 10 presented in FIG. 2A. Said zone comprises a working electrode 12 and a counter-electrode 13 of one and the same analysis cell. According to this embodiment, the counter-electrode 13 surrounds the working electrode 12, which is made of gold for example. The analysis support 10 thus carries the working electrode 12 and the counter-electrode 13 of each analysis cell.

FIG. 2C shows a cross section through the zone 11 of the analysis support 10 of FIG. 2B. Identical numerical references denote identical elements in FIGS. 2A to 2C.

The width 14 of the zone 11 comprising the working electrode 12 and the counter-electrode 13 may be for example 740 μm, the diameter 15 of the working electrode may be 500 μm, and the distance separating the working electrode 12 and the counter-electrode 13 may be approximately 30 μm.

The zones 11 comprising electrodes of different analysis cells may be separated by approximately 500 μm.

It will be understood that a high degree of modularity is possible in terms of the shape, distribution and type of the different electrodes.

The analysis support 10 may be produced according to the conventional techniques relating to microelectronics (for example vacuum metallisation). It may be made for example of a plastics material, a resin or of silicon.

In the case where the potentials are applied successively to the different working electrodes so that the measurements are carried out in succession, there may be provided just one single reference electrode which is common to the different analysis cells. According to the described embodiment, a saturated calomel electrode was used, and is placed directly in the sample of the solution to be analysed, opposite the working electrodes. Furthermore, the counter-electrodes 13 of the different cells may be connected to one another. This makes it possible to simplify the method of production of the analysis support by reducing the number of connections required.

As mentioned above, it may also be provided that the reference electrode(s) is/are located on an additional support placed opposite the analysis support.

FIGS. 3A and 3B respectively show, for an imposed potential (for FIG. 3A, Eᵢₘₚ=+0.4 V), the current response as a function of time which is obtained for one analysis cell, and the voltammogram which is obtained after plotting the current values obtained for the different cells at a time “t” that is constant, based on an analysis support with twenty cells as shown in FIGS. 2A to 2C.

As in the previous case illustrated in FIG. 1, the solution analysed is a solution of Fe³⁺ at a concentration of 10⁻² mol/l⁻¹ in sulphuric acid H₂SO₄ at 0.5 mol/l⁻¹.

The method used is potential step voltammetry on a gold electrode with a saturated calomel electrode as the reference electrode.

A base potential E₁ of 550 mV is applied to the working electrode of a first cell, and after a time t₁=100 ms the potential is changed to E₂=500 mV for t₂=500 ms. The current response is recorded at the time t₃=150 ms. On the working electrode of a second cell, the initial potential E₁ remains the same (550 mV), but after 100 ms the potential is changed to E₂=450 mV for t₂=500 ms. Here again, the current intensity is recorded at t₃=150 ms. The other points are obtained in the same way, each time by lowering the potential E₂ by 50 mV. FIG. 3A shows the current response obtained for a given analysis cell as a function of time.

FIG. 3B shows the voltammogram obtained after plotting the current values obtained for the twenty different cells at a time “t” that is constant, based on an analysis support with twenty cells as shown in FIGS. 2A to 2C. The points represented by a square correspond to the measurements obtained for the solution containing iron, and the curve of the points represented by circles corresponds to the “control”, that is to say to the measurements obtained for the same solution that does not contain iron.

A curve is effectively obtained which is similar to the curve obtained according to the known prior art technique based on a rotating gold electrode, as shown in FIG. 1. The following values were obtained for the Iₗᵢₘᵢₜ and for the half-wave potential E_{1/2}: Iₗᵢₘᵢₜ=23 μA and E_{1/2}=0.06 V.

As in the previous case illustrating a technique from the prior art, a value of 0.06 V is thus obtained for the half-wave potential E_{1/2}, this being characteristic of the pair Fe²⁺/Fe³⁺ under these analysis conditions.

FIG. 4 shows a voltammogram obtained according to the method of the invention under the same experimental conditions as above, with a solution that is ten times less concentrated with Fe³⁺, that is to say Fe³⁺ at 10⁻³ mol/l⁻¹ in sulphuric acid H₂SO₄ at 0.5 mol/l⁻¹. A value for the Iₗᵢₘᵢₜ of 2.1 μA was obtained on the basis of this curve.

The Iₗᵢₘᵢₜ depends on the concentration of the chemical species. In the present case, it can thus be seen that reducing the Fe³⁺ concentration by a factor of ten compared to the previous voltammogram shown in FIG. 3B effectively corresponds essentially to a decrease in the value of the Iₗᵢₘᵢₜ also by a factor of ten.

There is always a residual current corresponding to the sum of a capacitive current and to the reactions inherent in the solvent (for example decomposition of water into hydrogen in the field of cathode potentials). It is therefore beneficial to subtract this residual current from the experimental current.

It is also possible to carry out the analysis of this solution of Fe³⁺ at 10⁻³ mol/l⁻¹ in sulphuric acid H₂SO₄ at 0.5 mol/l⁻¹ with a better sensitivity by means of the method according to the invention by making direct use of the method of differential pulse voltammetry.

An initial potential of 400 mV is imposed on a working electrode of an analysis cell for 6 s, followed by a pulse (ΔE) of 50 mV for 1 s. For the measurements by the other analysis cells, the initial potential imposed on the different working electrodes is progressively reduced by 20 mV for each of the analysis cells.

The current response over time for one analysis cell is shown in FIG. 5A.

The differences in the current responses at constant times t₁ and t₂ respectively before and after the pulse gives the desired current value and makes it possible to create the curve shown in FIG. 5B. The recorded values correspond to the current values at the times t₁=5.995 s and t₂=6.995 s.

The method according to the invention therefore makes it possible to analyse chemical species in a liquid solution or a gas, making it possible to rapidly obtain one or more voltammograms of a sample.

This is because the independent potentials can be applied simultaneously to the different cells and therefore all of the measurements can be carried out simultaneously. The voltammogram(s) can therefore be created very rapidly. Moreover, the fact that a single measurement is carried out for each analysis cell ensures that the working electrode and the sample are renewed for each measurement.

Furthermore, it is possible to create a plurality of voltammograms from one and the same analysis support by combining different voltammetric methods, for example by applying different variations in potential to certain sets of support cells.

Moreover, it is possible for the working electrodes of the different cells to be of different types. Thus, one and the same support can make it possible to analyse species with very different redox potentials.

In a solution of H₂SO₄ for example, a working electrode made of copper can make it possible to analyse compounds with a redox potential in the range from −0.8 to 0 V, and a working electrode made of gold is suitable for an analysis in the range from −0.4 to 0.8 V.

The reactivity of the species is associated with their interaction with the surface of the working electrode (greater or lesser adsorption, metallic or covalent bonding, etc.). Consequently, the reactivity of the different chemical species varies depending on the type of working electrode.

FIGS. 6A, 6B and 6C aim to illustrate this point.

FIG. 6A shows the voltammograms obtained for a solution of Cu²⁺ at 10⁻³ mol/l⁻¹ by potential step voltammetry on a copper electrode and on a gold electrode, with a saturated calomel electrode as the reference electrode.

The two curves obtained show that the response of the copper is much greater on the copper electrode than on the gold electrode, and furthermore shows that the reduction potentials of the copper depend on the type of working electrode used.

FIG. 6B shows the voltammograms obtained for a solution of Cu²⁺ at 10⁻³ mol/l⁻¹ and a solution of Fe³⁺ at 10⁻³ mol/l⁻¹ by potential step voltammetry on a gold electrode, with a saturated calomel electrode as the reference electrode.

The two curves obtained show that the response of the iron on the gold electrode is much greater than the response of the copper. Furthermore, the initial reduction potential of the iron is approximately 500 mV whereas that of the copper is approximately 350 mV.

FIG. 6C shows the voltammograms obtained for a solution of Cu²⁺ at 10⁻² mol/l⁻¹ and a solution of Fe³⁺ at 10⁻² mol/l⁻¹ by potential step voltammetry on a copper electrode, with a saturated calomel electrode as the reference electrode.

The two curves obtained show that the response of the iron on the copper electrode is comparable with the response of the copper. Furthermore, the initial reduction potential of the iron is approximately −50 mV whereas that of the copper is approximately −300 mV.

These curves therefore show that effectively the reactivity of the chemical species varies depending on the type of electrode. Producing and using a support which has analysis cells with working electrodes of different types makes it possible to obtain a plurality of voltammograms and to analyse a greater number of chemical species during one and the same analysis.

Furthermore, a comparison of the different voltammograms obtained allows a better determination and analysis of the voltammograms and of the species present. In the case presented above, it can be seen that the reactivity of the copper and of the iron is similar on a copper electrode, but this is not the case on a gold electrode. Therefore, if a voltammogram is simultaneously created with a gold electrode for example, it will be easy to determine whether the first voltammogram obtained characterises the copper or the iron present in the sample.

The technique according to the invention therefore makes it possible to carry out rigorous measurements with renewal of the electrode and of the sample for each measurement, and moreover offers a high degree of modularity.

It is possible to refine the analyses by increasing the number of cells used in order to create a voltammogram, to simultaneously study several potential ranges, to apply several voltammetric analysis methods simultaneously, and to vary the type of working electrodes of the cells of one and the same analysis support.

1-11. (canceled)

12. A method for voltammetric electrochemical analysis of a liquid solution, which makes it possible to detect and/or assay at least one chemical species in said solution, comprising a step which consists in bringing a sample of said solution into contact with a single analysis support which has a plurality of working electrodes, each belonging to a separate electrochemical analysis cell, each analysis cell furthermore comprising a counter-electrode and a reference electrode;
characterized in that it comprises the following steps:
applying an independent and different potential to each of said working electrodes;
measuring, by means of a single and different measurement of said sample in each of said analysis cells, the current response at a time t that is constant for all of said analysis cells;
reconstructing at least one voltammogram of said sample, based on said measurements;
deducing, from said voltammogram, information relating to the detection and/or assaying of said at least one chemical species in said sample.

13. The method according to any one of claims 12 or 13, characterized in that said measurements carried out make it possible to implement at least one voltammetric analysis belonging to the group comprising: potential step voltammetry; normal pulse voltammetry; and differential pulse voltammetry.

14. The method according to claim 12 or 13, characterized in that said measurements are carried out simultaneously by said analysis cells.

15. The method according to claim 12 or 13, characterized in that one counter-electrode and/or one reference electrode is common to all of said analysis cells.

16. The method according to claim 15, characterized in that said measurements are carried out in succession by said analysis cells.

17. The method according to any one of claims 12 to 16, characterized in that at least ten measurements are carried out.

18. The method according to any one of claims 12 to 17, characterized in that the working electrodes are chemically modified.

19. The method according to any one of claims 1 to 18, characterized in that it is implemented on an analysis support which has a plurality of zones containing the working electrode distributed in one or more rows.

20. The method according to any one of claims 12 to 19, characterized in that said working electrodes are of the same type.

21. The method according to any one of claims 12 to 19, characterized in that said working electrodes are of different types.

22. The method according to claims 19 and 21, characterized in that it is implemented with working electrodes of different types which are located in different rows.
